(19) United States
(12) Patent Application Publication
(10) Pub. No.: US 2025/0300698 A1
(43) Pub. Date: Sep. 25, 2025

(54) DEVICE AND METHOD FOR ESTIMATING CHANNEL RELATED TO REFLECTING INTELLIGENT SURFACE IN WIRELESS COMMUNICATION SYSTEM

(71) Applicants: LG ELECTRONICS INC., Seoul (KR); KOREA ADVANCED INSTITUTE OF SCIENCE AND TECHNOLOGY, Daejeon (KR)

(72) Inventors: Jaeky OH, Seoul (KR); Junil CHOI, Daejeon (KR); Jaehoon CHUNG, Seoul (KR); Gyoseung LEE, Daejeon (KR); Hyeongtaek LEE, Daejeon (KR)

(73) Assignees: LG ELECTRONICS INC., Seoul (KR); KOREA ADVANCED INSTITUTE OF SCIENCE AND TECHNOLOGY, Daejeon (KR)

(21) Appl. No.: 18/862,135

(22) PCT Filed: May 20, 2022
(86) PCT No.: PCT/KR2022/007237

§ 371 Date: Oct. 31, 2024

(51) Int. Cl. H04B 7/04; H04B 17/309; H04W 72/1273

(52) U.S. Cl. CPC H04B 7/04013; H04B 17/309; H04W 72/1273

(57) ABSTRACT

In order to estimate a channel in a wireless communication system, a method of operating a base station may comprise transmitting configuration information for at least one downlink reference signal, transmitting the at least one downlink reference signal, transmitting configuration information for an uplink reference signal to at least one user equipment (UE), receiving channel information from a reflecting intelligent surface (RIS), transmitting control information indicating a scheduling result for transmitting downlink data to the at least one UE, and transmitting the downlink data to the at least one UE according to the scheduling result.

### CROSS-REFERENCE TO RELATED APPLICATION(S)

This application is the National Stage filing under 35 U.S.C. 371 of International Application No. PCT/KR2022/007237, filed on May 20, 2022, the contents of which are all incorporated by reference herein in its entirety.

### TECHNICAL FIELD

The following description relates to a wireless communication system, and to a device and method for estimating a channel related to a reflecting intelligent surface (RIS) in a wireless communication system.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

In particular, as a large number of communication devices require a large communication capacity, the enhanced mobile broadband (eMBB) communication technology, as compared to the conventional radio access technology (RAT), is being proposed. In addition, not only massive machine type communications (massive MTC), which provide a variety of services anytime and anywhere by connecting multiple devices and objects, but also a communication system considering a service/user equipment (UE) sensitive to reliability and latency is being proposed. Various technical configurations for this are being proposed.

### SUMMARY

The present disclosure can provide a method and device for effectively estimating a channel in an environment using a reflecting intelligent surface (RIS) in a wireless communication system.

The present disclosure can provide a method and device for estimating a channel using active elements included in a RIS in a wireless communication system.

The present disclosure can provide a method and device for estimating a channel between at least one user equipment (UE) and a RIS in a wireless communication system.

The present disclosure can provide a method and device for performing measurements on reference signals in a RIS in a wireless communication system.

The present disclosure can provide a method and device for estimating channels between a base station, a RIS, and at least one UE based on measurements on reference signals performed in the RIS in a wireless communication system.

The present disclosure can provide a method and device for estimating a channel based on information acquired using active elements of a RIS in a wireless communication system.

The present disclosure can provide a method and device for estimating channels for remaining elements from channel information for a portion of elements of a RIS in a wireless communication system.

The present disclosure can provide a method and device for estimating channels for each element based on correlations between elements of a RIS in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

As an example of the present disclosure, a method of operating a base station in a wireless communication system may comprise transmitting configuration information for at least one downlink reference signal, transmitting the at least one downlink reference signal, transmitting configuration information for an uplink reference signal to at least one user equipment (UE), receiving channel information from a reflecting intelligent surface (RIS), transmitting control information indicating a scheduling result for transmitting downlink data to the at least one UE, and transmitting the downlink data to the at least one UE according to the scheduling result. The channel information may comprise channels values channel values for a portion and a remainder of elements determined based on reception values of the uplink reference signal and the downlink reference signal measured using the portion of the elements included in the RIS.

As an example of the present disclosure, a method of operating a reflecting intelligent surface (RIS) device in a wireless communication system may comprise receiving reference signals from a base station and at least one user equipment (UE) using a portion of elements, performing measurement on the reference signals, estimating a first partial channel related to a portion of channels for elements included in the RIS based on a result of the measurement, estimating a second partial channel related to the remaining elements excluding the portion of elements based on the first partial channel, and transmitting information on a channel including the first partial channel and the second partial channel to the base station.

As an example of the present disclosure, a base station in a wireless communication system may comprise a transceiver and a processor connected to the transceiver. The processor may transmit configuration information for at least one downlink reference signal, transmit the at least one downlink reference signal, transmit configuration information for an uplink reference signal to at least one user equipment (UE), receive channel information from a reflecting intelligent surface (RIS), transmit control information indicating a scheduling result for transmitting downlink data to the at least one UE, and transmit the downlink data to the at least one UE according to the scheduling result. The channel information may comprise channels values channel values for a portion and a remainder of elements determined based on reception values of the uplink reference signal and the downlink reference signal measured using the portion of the elements included in the RIS.

As an example of the present disclosure, a communication apparatus may comprise at least one processor and at least one computer memory connected to the at least one processor and configured to store instructions directing operations when executed by the at least one processor. The operations may comprise transmitting configuration information for at least one downlink reference signal, transmitting the at least one downlink reference signal, transmitting configuration information for an uplink reference signal to at least one user equipment (UE), receiving channel information from a reflecting intelligent surface (RIS), transmitting control information indicating a scheduling result for transmitting downlink data to the at least one UE, and transmitting the downlink data to the at least one UE according to the scheduling result. The channel information may comprise channels values channel values for a portion and a remainder of elements determined based on reception values of the uplink reference signal and the downlink reference signal measured using the portion of the elements included in the RIS.

As an example of the present disclosure, a non-transitory computer-readable medium storing at least one instruction may comprise the at least one instruction executable by a processor. The at least one instruction may control a device to transmit configuration information for at least one downlink reference signal, transmit the at least one downlink reference signal, transmit configuration information for an uplink reference signal to at least one user equipment (UE), receive channel information from a reflecting intelligent surface (RIS), transmit control information indicating a scheduling result for transmitting downlink data to the at least one UE and transmit the downlink data to the at least one UE according to the scheduling result. The channel information may comprise channels values channel values for a portion and a remainder of elements determined based on reception values of the uplink reference signal and the downlink reference signal measured using the portion of the elements included in the RIS.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

As is apparent from the above description, the embodiments of the present disclosure have the following effects.

According to the present disclosure, a channel can be effectively estimated in an environment using a reflecting intelligent surface (RIS).

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates another example of a wireless device applicable to the present disclosure.

FIG. 4 illustrates an example of a hand-held device applicable to the present disclosure.

FIG. 5 illustrates an example of a car or an autonomous driving car applicable to the present disclosure.

FIG. 6 illustrates an example of an AI device applied to the present disclosure.

FIG. 7 illustrates a method of processing a transmitted signal applied to the present disclosure.

FIG. 8 illustrates an example of a communication structure providable in a 6G system applicable to the present disclosure.

FIG. 9 illustrates an electromagnetic spectrum applicable to the present disclosure.

FIG. 10 illustrates a THz communication method applicable to the present disclosure.

FIG. 11 shows a communication environment including a reflecting intelligent surface (RIS) according to an embodiment of the present disclosure.

FIG. 12 shows a probability distribution of a rank according to the number of active elements in a RIS according to an embodiment of the present disclosure.

FIG. 13 shows an example of channel estimation and communication timing according to an embodiment of the present disclosure.

FIG. 14 shows an example of a downlink communication procedure according to an embodiment of the present disclosure.

FIG. 15 shows an example of a procedure for receiving downlink data according to an embodiment of the present disclosure.

FIG. 16 shows an example of a procedure for transmitting downlink data according to an embodiment of the present disclosure.

FIG. 17 shows an example of a procedure for estimating a channel according to an embodiment of the present disclosure.

FIG. 18 shows an example of a procedure for determining and estimating a channel value related to a passive element according to an embodiment of the present disclosure.

FIG. 19, FIG. 20 and FIG. 21 show the performance of a channel estimation technique according to an embodiment of the present disclosure.

### DETAILED DESCRIPTION

Following embodiments are achieved by combination of structural elements and features of the present disclosure in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present disclosure. The order of operations described in the embodiments of the present disclosure may be changed. Some structural elements or features of one embodiment may be included in another embodiment, or may be replaced with corresponding structural elements or features of another embodiment.

In the description of the drawings, procedures or steps which render the scope of the present disclosure unnecessarily ambiguous will be omitted and procedures or steps which can be understood by those skilled in the art will be omitted.

In the entire specification, when a certain portion “comprises” or “includes” a certain component, this indicates that the other components are not excluded, but may be further included unless specially described. The terms “unit”, “-or/er” and “module” described in the specification indicate a unit for processing at least one function or operation, which may be implemented by hardware, software and a combination thereof. In addition, “a or an”, “one” “the” and similar related words may be used as the sense of including both a singular representation and a plural representation unless it is indicated in the context describing the present specification (especially in the context of the following claims) to be different from this specification or is clearly contradicted by the context.

In this specification, the embodiments of the present disclosure are described with focus on the relationship of data reception and transmission between a base station and a mobile station. Herein, the base station means a terminal node of a network that performs direct communication with the mobile station. In this document, a specific operation, which is described to be performed by a base station, may be performed by an upper node of the base station in some cases.

That is, in a network consisting of a plurality of network nodes including abase station, various operations for communicating with a mobile station may be performed by the base station or network nodes other than the base station. Herein, “base station” may be replaced by such terms as “fixed station”, “Node B”, “eNode B(eNB)”, “gNode B(gNB)”, “ng-eNB”, “advanced base station(ABS)”, or “access point”.

Also, in the embodiments of the present disclosure, “terminal” may be replaced by such terms as “user equipment(UE)”, “mobile station(MS)”, “subscriber station(SS)”, “mobile subscriber station(MSS)”, “mobile terminal” or “advanced mobile station(AMS)”.

In addition, a transmission end refers to a fixed and/or mobile node that provides a data service or a voice service, and a reception end means a fixed and/or mobile node that receives a data service or a voice service. Accordingly, in the case of an uplink, a mobile station may be a transmission end, and a base station may be a reception end. Likewise, in the case of a downlink, a mobile station may be a reception end, and a base station may be a transmission end.

The embodiments of the present disclosure may be supported by standard documents disclosed in at least one of the following radio access systems: an IEEE 802 xx system, a 3rd generation partnership project (3GPP) system, a 3GPP long term evolution (LTE) system, a 3GPP 5th generation (5G) new radio (NR) system and a 3GPP2 system, and in particular, the embodiments of the present disclosure may be supported by the following documents: 3GPP TS (technical specification) 38.211, 3GPP TS 38.212, 3GPP TS 38.213, 3GPP TS 38.321, and 3GPP TS 38.331.

In addition, the embodiments of the present disclosure are applicable to another radio access system but is not limited to the above-described system. As an example, they are applicable to a system applied after a 3GPP 5G NR system and are not limited to a specific system.

That is, obvious steps and parts not described in the embodiments of the present disclosure may be described with reference to the above documents. In addition, all the terms disclosed in this document may be explained by the standard document.

Hereinafter, a preferred embodiment according to the present disclosure will be described in detail with reference to accompanying drawings. Detailed descriptions disclosed below together with accompanying drawings are intended to describe example embodiments of the present disclosure and not intended to show any sole embodiment in which a technical configuration of the present disclosure can be implemented.

In addition, specific terms used in the embodiments of the present disclosure are provided to help understand the present disclosure, and such specific terms may be used in any other modified forms without departing from the technical idea of the present disclosure.

The following technology may be applied to various radio access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA) and the like.

For clarity of explanation, the descriptions below are based on a 3GPP communication system (e.g. LTE, NR and the like), but the technical idea of the present disclosure is not limited thereto. LTE may mean a technology after 3GPP TS 36.xxx Release 8. Specifically, the LTE technology after 3GPP TS 36.xxx Release 10 may be referred to as LTE-A, and the one after 3GPP TS 36.xxx Release 13 may be referred to as LTE-A pro. 3GPP NR may mean a technology after TS 38.xxx Release 15. 3GPP 6G may mean a technology after TS Release 17 and/or Release 18. “xxx’ means the specific number of a standard document. LTE/NR/6G may be referred to collectively as 3GPP system.

Contents described in standard documents released earlier than the present disclosure may be referred to for the background art, terms and abbreviations used in the present disclosure. As an example, 36.xxx and 38.xxx standard documents may be referred to.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

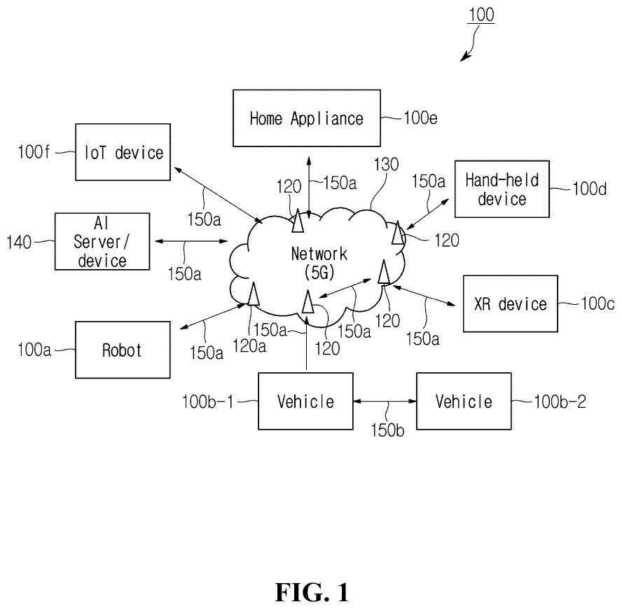

FIG. 1 is a view showing an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5GNR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

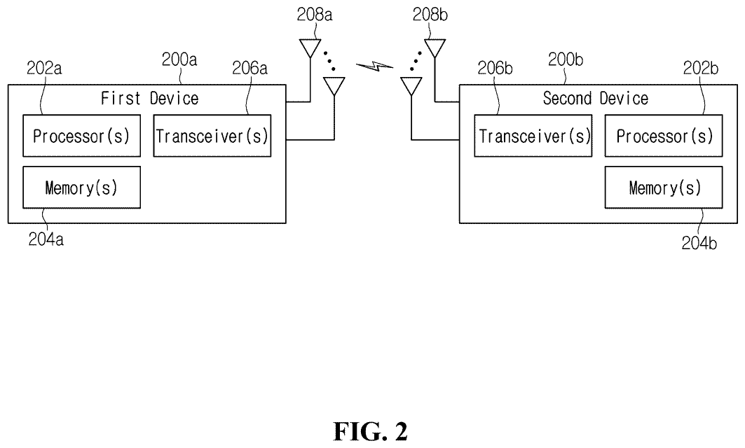

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

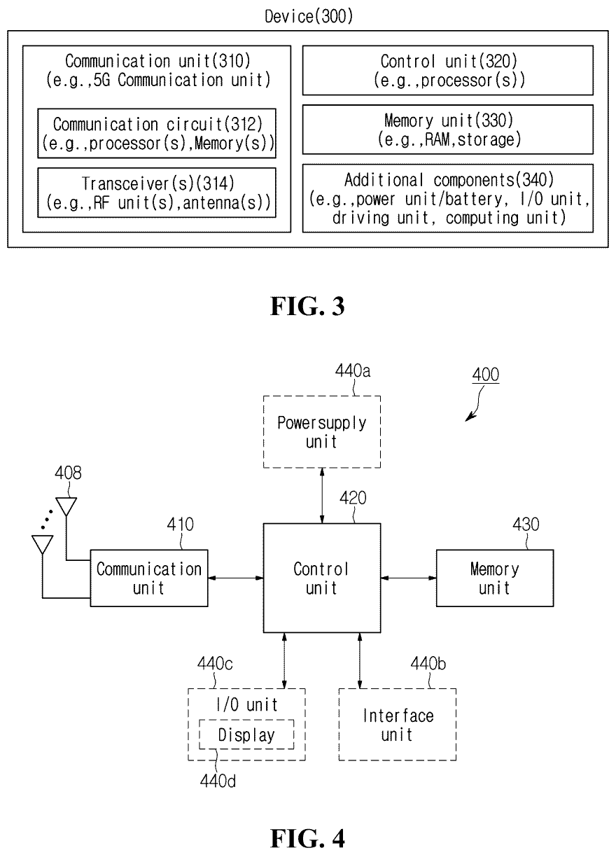

FIG. 3 is a view showing another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIG. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 4 is a view showing an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

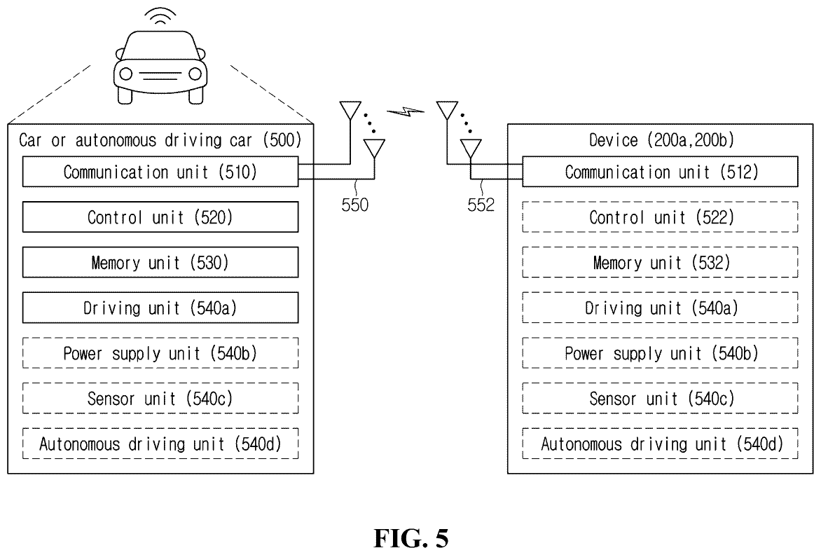

FIG. 5 is a view showing an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

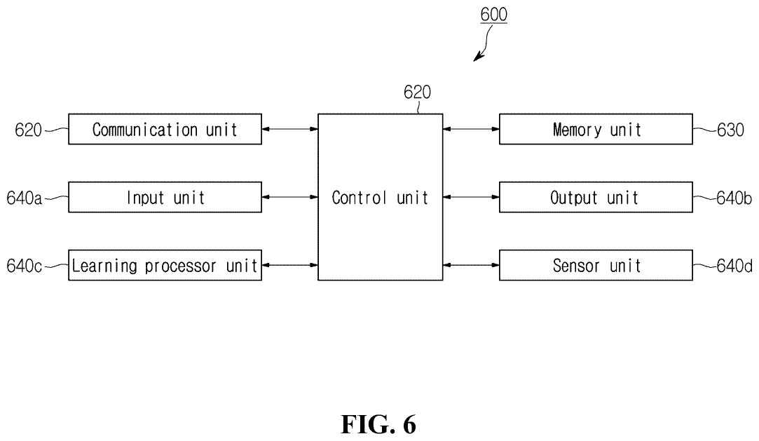

FIG. 6 is a diagram illustrating an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 6, the AI device 600 may include a communication unit 610, a control unit 620, a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AI device 600 to perform predicted operation or operation determined to be preferred among at least one executable operation. In addition, the control unit 620 collects history information including a user's feedback on the operation content or operation of the AI device 600, and stores it in the memory unit 630 or the learning processor 640c or transmit it to an external device such as the AI server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning, input data to which the learning model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition, the output value of the learning processor unit 640c may be transmitted to an external device through the communication unit 610 and/or stored in the memory unit 630.

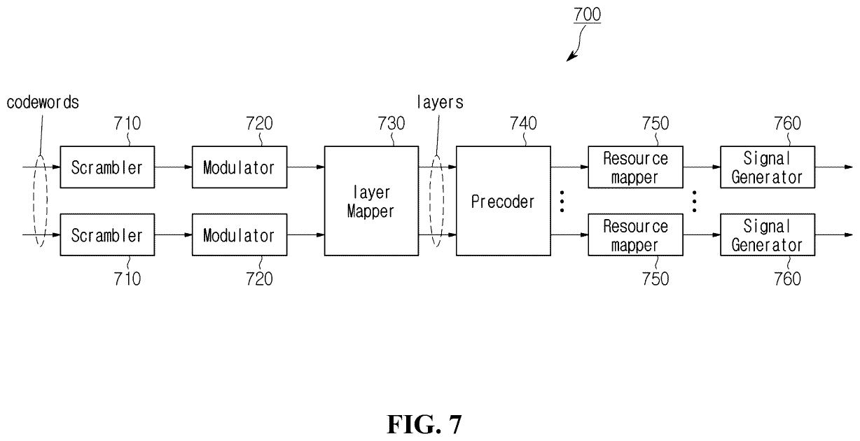

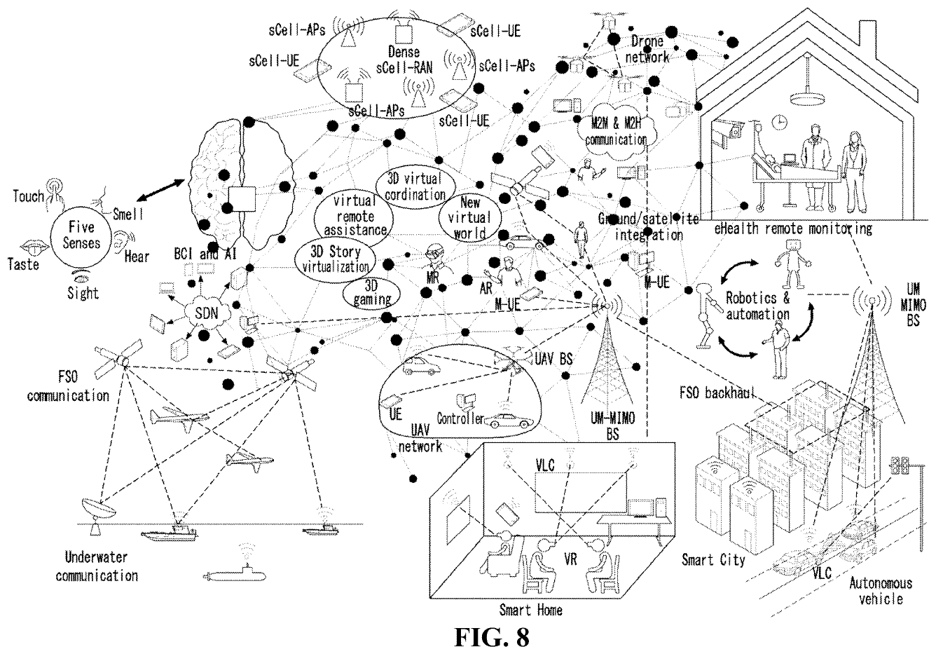

FIG. 7 is a diagram illustrating a method of processing a transmitted signal applied to the present disclosure. For example, the transmitted signal may be processed by a signal processing circuit. In this case, the signal processing circuit 700 may include a scrambler 710, a modulator 720, a layer mapper 730, a precoder 740, a resource mapper 750, and a signal generator 760. At this time, as an example, the operation/function of FIG. 7 may be performed by the processors 202a and 202b and/or the transceivers 206a and 206b of FIG. 2. Also, as an example, the hardware elements of FIG. 7 may be implemented in the processors 202a and 202b and/or the transceivers 206a and 206b of FIG. 2. As an example, blocks 710 to 760 may be implemented in the processors 202a and 202b of FIG. 2. Also, blocks 710 to 750 may be implemented in the processors 202a and 202b of FIG. 2, and block 760 may be implemented in the transceivers 206a and 206b of FIG. 2, and are not limited to the above-described embodiment.

A codeword may be converted into a radio signal through the signal processing circuit 700 of FIG. 7. Here, the codeword is an encoded bit sequence of an information block. Information blocks may include transport blocks (e.g., UL-SCH transport blocks, DL-SCH transport blocks). The radio signal may be transmitted through various physical channels (e.g., PUSCH, PDSCH). Specifically, the codeword may be converted into a scrambled bit sequence by the scrambler 710. A scramble sequence used for scrambling is generated based on an initialization value, and the initialization value may include ID information of a wireless device. The scrambled bit sequence may be modulated into a modulation symbol sequence by the modulator 720. The modulation method may include pi/2-binary phase shift keying (pi/2-BPSK), m-phase shift keying (m-PSK), m-quadrature amplitude modulation (m-QAM), and the like.

A complex modulation symbol sequence may be mapped to one or more transport layers by the layer mapper 730. Modulation symbols of each transport layer may be mapped to corresponding antenna port(s) by the precoder 740 (precoding). The output z of the precoder 740 may be obtained by multiplying the output y of the layer mapper 730 by a N*M precoding matrix W. Here, N is the number of antenna ports and M is the number of transport layers. Here, the precoder 740 may perform precoding after transform precoding (e.g., discrete Fourier transform (DFT)) on complex modulation symbols. Also, the precoder 740 may perform precoding without performing transform precoding.

The resource mapper 750 may map modulation symbols of each antenna port to time-frequency resources. The time-frequency resources may include a plurality of symbols (e.g., CP-OFDMA symbols and DFT-s-OFDMA symbols) in the time domain and may include a plurality of subcarriers in the frequency domain. The signal generator 760 generates a radio signal from the mapped modulation symbols, and the generated radio signal may be transmitted to other devices through each antenna. To this end, the signal generator 760 may include an inverse fast Fourier transform (IFFT) module, a cyclic prefix (CP) inserter, a digital-to-analog converter (DAC), a frequency uplink converter, and the like.

A signal processing process for a received signal in a wireless device may be configured as the reverse of the signal processing processes 710 to 760 of FIG. 7. For example, a wireless device (e.g., 200a and 200b of FIG. 2) may receive a radio signal from the outside through an antenna port/transceiver. The received radio signal may be converted into a baseband signal through a signal reconstructor. To this end, the signal reconstructor may include a frequency downlink converter, an analog-to-digital converter (ADC), a CP remover, and a fast Fourier transform (FFT) module. Thereafter, the baseband signal may be reconstructed to a codeword through a resource de-mapper process, a postcoding process, a demodulation process, and a de-scramble process. The codeword may be reconstructed to an original information block through decoding. Accordingly, a signal processing circuit (not shown) for a received signal may include a signal reconstructor, a resource de-mapper, a postcoder, a demodulator, a de-scrambler, and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

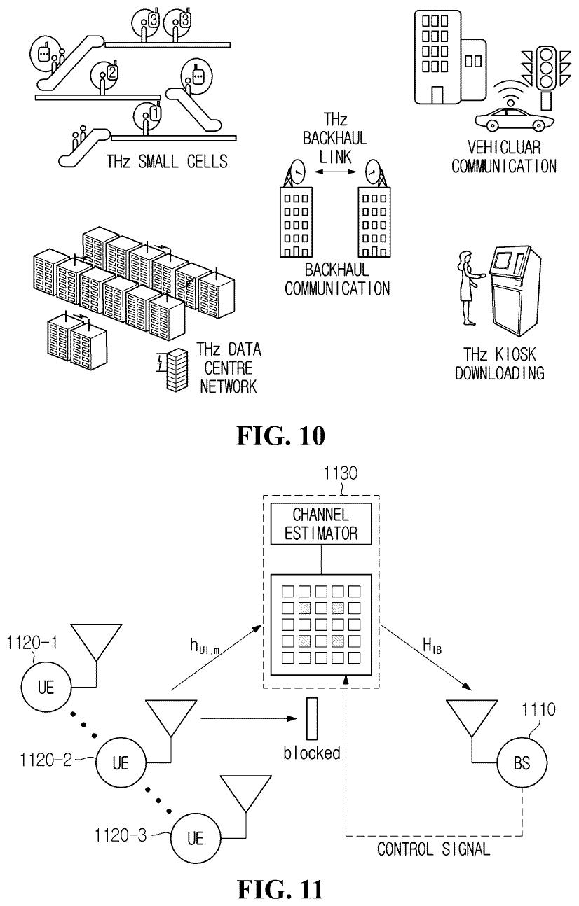

FIG. 10 is a view showing an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System—Terahertz (THz) Communication

THz communication is applicable to the 6G system. For example, a data rate may increase by increasing bandwidth. This may be performed by using sub-TH communication with wide bandwidth and applying advanced massive MIMO technology.

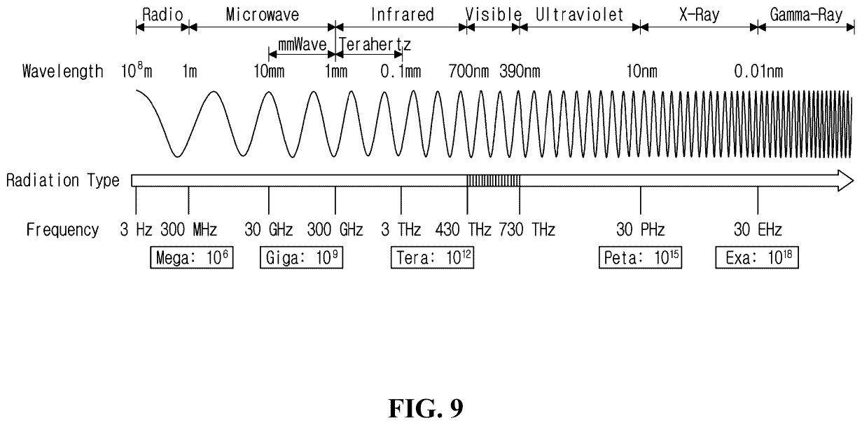

FIG. 9 is a view showing an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

FIG. 10 is a view showing a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Reflecting Intelligent Surface (RIS)

A RIS is one of the major new technology candidates for future wireless communications, and is a surface equipped with multiple elements that reflect signals. Each element may independently change the phase of colliding electromagnetic waves. One of the main features of the RIS is that it is controllable, so that the phase change rate of each element may be adjusted in real time. Based on the adjustment of the phase change rate, it is possible to modify a wireless communication channel in real time, such as increasing an information transmission rate or assisting a device that cannot receive a signal. In addition, since it uses passive elements that only support signal reflection, the RIS may be implemented at a low price and with low power consumption.

Metamaterials, which are elements that cause signal reflection, may be implemented in various ways. For example, metamaterials may be implemented based on a diode method using metal materials, a method using liquid crystal, and a method using graphene (e.g., a method of combining graphene and metal using surface Plasmon polariton (SPP)). Metamaterials may be implemented in various ways other than these. Elements composed of metamaterials may be controlled by a controller. The controller may control each element, thereby adjusting the phase change rate applied when a signal is reflected from each element. For example, a base station or a separate device may function as a controller.

In some cases, the RIS may include active elements in addition to passive elements. The active elements are elements that have the ability to process received signals rather than simply reflecting them. The active elements may be implemented by connecting a receiving RF chain to the passive elements. Although the low cost and low complexity characteristics of the RIS, which are some of its advantages, may be weakened due to the active elements, the active elements may enable more diverse and flexible system operation. The active elements are also referred to as active sensors.

### SPECIFIC EMBODIMENTS OF THE PRESENT DISCLOSURE

The present disclosure relates to estimating a channel related to a RIS in a wireless communication system. Specifically, the present disclosure describes a technique for estimating a channel of a link between a UE and a RIS and a link between a base station and a RIS by using at least one active element in an environment where a RIS including at least one active element is used. In the following description, the RIS is used as an expression referring to a device that reflects a signal using multiple elements, but it may also be referred to as an ‘IRS (intelligent reflecting surface)’.

The RIS is attracting attention as a technique for improving communication performance in post-5G communications. In communication systems using the RIS, beamforming techniques are being actively studied to reduce power consumption of transmitters and receivers or increase data transmission rates. In order to ensure the performance of the beamformer, it is essential to know accurate channel information. However, if a communication system adopts the RIS, it is difficult to use existing channel estimation techniques without change.

If the RIS consists of only passive elements, the RIS cannot perform independent signal transmission/reception. Therefore, in this case, it is difficult to independently estimate a channel between the base station and the RIS or the UE and the RIS, and only the estimation of the cascaded channel through the RIS is possible. In addition, in a communication system including a RIS consisting of only passive elements, the training overhead of channel estimation increases in proportion to the number of elements of the RIS. If a large number of elements are used to improve communication performance, the training overhead increases significantly, making it difficult to apply to a practical communication system. One of the method of solving this problem is to configure portion of the elements of the RIS using active elements. The active elements have the ability to independently receive signals through a reception RF (radio frequency) chain. By using active elements, the channel between the base station and the RIS and the channel between the UE and the RIS can be independently estimated, and the training overhead can be significantly reduced by using a small number of active elements among the total elements. However, since only partial information about the entire channel can be obtained through active elements, a new channel estimation technique is needed that can estimate the entire channel using the obtained information.

FIG. 11 shows a communication environment including a RIS according to an embodiment of the present disclosure. Referring to FIG. 11, a base station 1110 and a plurality of UEs 1120-1 to 1120-3 perform communication, and a RIS 1130 may assist signal transmission between the base station 1110 and the plurality of UEs 1120-1 to 1120-3.

Referring to FIG. 11, the base station 1110 equipped with N antennas and the UEs 1120-1 to 1120-3 equipped with a single antenna may perform uplink communication. In addition, the RIS 1130 equipped with L elements is arranged to improve communication performance between the base station 1110 and the UEs 1120-1 to 1120-3. According to various embodiments, the RIS 1130 operates as a passive element in which Lₚₐₛ elements among the L elements reflect signals, and the remaining L_{act}(=L−Lₚₐ«L) active elements have the signal reception capability. The active elements may be implemented by connecting L_{act} elements among the elements of the RIS 1130 to an RF (radio frequency) chain.

In addition, the connection relationship between the elements of the RIS 1130 and the RF chain may be controlled by a switching network controlled by the base station 1110, and it is assumed that the switching network may be changed in real time. That is, the arrangement of the active elements is not fixed, but may be adjusted by electronic control. Accordingly, when a reference signal is transmitted during multiple transmission occasions, the arrangement of the active elements may be set for each transmission occasion. Accordingly, the arrangement of the active elements may be different in each transmission occasion.

As described above, portion of the elements of the RIS 1130 may be designed as active elements and the remaining elements as passive elements. The active elements and passive elements are distinguished based on whether they have signal reception or measurement capabilities, and may be referred to as ‘first type elements’ and ‘second type elements’.

In an environment such as FIG. 11, the present disclosure proposes a channel estimation technique utilizing the active elements of the RIS applicable to a MU (multi-user)-MISO (multiple input single output) system according to a TDD (time division duplex) scheme. It is assumed that the channel between the base station and the UE that does not pass through the RIS is blocked by an obstacle. An uplink reception signal at the base station may be expressed as in [Equation 1] below.

$$y = {\sum }_{m = 1}^{M} {H}_{IB} Θ {h}_{UI , m} {s}_{m} + {n}_{B S} \qquad [ Equation 1 ]$$

In [Equation 1], y denotes a received signal at the base station, M denotes the number of UEs, HIB denotes a channel between the RIS and the base station, Θ denotes the reflection coefficients of the elements of the RIS, h_{UI,m} denotes a channel between the m-th UE and the RIS, sₘ denotes a transmitted signal, and n_{BS} denotes noise received at the base station.

The RIS is located in an isotropic scattering environment, and the channel between the base station and the RIS and the channel between the UE and the RIS may be assumed as a correlated Rayleigh channel model with correlation. The channel model assumes that there are innumerable multipath elements, but the present disclosure first assumes that there are a finite number of multipaths in order to express the correlation. Assuming that there are P multipaths between the m-th UE and the RIS, the channel between the m-th UE and the RIS may be expressed as in [Equation 2] below.

$${h}_{UI , m} = {\sum }_{p = 1}^{P} \frac{{c}_{p}}{\sqrt{P}} a ( {ϕ}_{p} , {θ}_{p} ) \qquad [ Equation 2 ]$$

In [Equation 2], h_{UI,m} denotes the channel between the m-th UE and the RIS, P denotes the number of multipaths, cₚ denotes a signal attenuation coefficient for a p-th path, φₚ denotes an azimuth angle at the RIS of the p-th path, θₚ denotes an elevation angle at the RIS of the p-th path, and a(φₚ,θₚ) denotes an array response vector at the RIS.

In [Equation 2], c₁, . . . , c_{P} are mutually independent and have the same distribution, and the mean of c₁, . . . , c_{P} is 0 and the variance is Aμ₁. Here, μ₁ denotes the average intensity attenuation of the signal between the UE and the RIS. If P→∞, h_{UI,m}→ [symbol] (0,Aμ₁R) is satisfied by the central limit theorem. Here, Aμ₁R is a covariance matrix between the UEs and the RIS with L×L dimension. The correlation between the UEs and the RIS may be expressed as a normalized spatial correlation matrix R, and R may be obtained as shown in [Equation 3] below.

$$R = \frac{1}{A {μ}_{1}} E \{ {h}_{UI , m} {h}_{UI , m}^{H} \} \qquad [ Equation 3 ]$$

In [Equation 3], R denotes the normalized spatial correlation matrix, Aμ₁ denotes the variance of the signal attenuation coefficients of the multipaths, E{ } denotes an averaging operator, and h_{UI,m} denotes the channel between the m-th UE and the RIS.

The values of each element of R in [Equation 3] are given as follows.

$${[ R ]}_{a , b} = sinc ( \frac{2 ‖ {u}_{a} - {u}_{b} ‖}{λ} ) , a , b = 1 , … , L \qquad [ Equation 4 ]$$

In [Equation 4], [R]_{a,b} denotes elements of the a-th row and b-th column of the normalized spatial correlation matrix, uₐ denotes the position vector of the a-th element of the RIS, u_{b} denotes the position vector of the b-th element of the RIS, and λ denotes the wavelength of the signal. uₐ may be defined as [0,i(a)dₕ,j(a)dᵥ]T, where i(a)=mod(a−1,Lₕ), j(a)=└(a−1)/Lₕ┘. If the UE is several wavelengths away, the channel between each UE and the RIS may be linearly independent. Therefore, the channel between the m-th UE and the RIS may be expressed as in [Equation 5] below.

$${h}_{UI , m} = ( 0 , {Aμ}_{1} R ) , m = 1 , … , M \qquad [ Equation 5 ]$$

In [Equation 5], h_{UI,m} denotes the channel between the m-th UE and the RIS, [symbol] ( ) denotes a multivariate normal distribution function, and Aμ₁R denotes a covariance matrix between the UE and the RIS with L×L dimension.

Using the channel reciprocity of the TDD system, the uplink channel between the RIS and the base station may be obtained from the downlink channel between the base station and the RIS. If the antennas of the base station are sufficiently separated, the channel between each antenna of the base station and the RIS may be defined similarly to [Equation 5] above. However, the covariance matrix is expressed as Aμ₂R using μ₂ denoting the average strength attenuation of the signal between the base station and the RIS.

Since the active elements of the RIS may receive and process signals, the channel between the base station and the RIS and the channel between the UE and the RIS may be estimated independently. The present disclosure proposes a technique for estimating the entire channel with a portion of channel information obtained by using the active elements in the RIS. The proposed technique is proposed using the Rayleigh channel model in an isotropic scattering environment, but is also applicable to other channel models such as a geometric channel. In the proposed technique, the operation of estimating the channel between the base station and the RIS and the operation of estimating the channel between the UEs and the RIS are similar, so the present disclosure describes the channel estimation between the UEs and the RIS.

First, the sub-channel between the UEs and the RIS may be estimated as follows. In the following description, a pilot is a signal having a promised value for channel estimation and may be referred to as a reference signal.

Each UE transmits an orthonormal pilot sequence for time τ_{U}. If the orthonormal pilot transmitted by the m-th UE is a vector with a size of τ_{U}×1 and is defined as φ(t)=[φₘ(1), . . . , φₘ(τ_{U})]^{T}, φ(t)=[φₘ(1), . . . , . . . , φₘ(τU)]^{T}, then the signal received at a t-th time slot in the active element of the RIS is as in [Equation 6] below.

$$x ( t ) = \sqrt{{P}_{U L}} {\sum }_{m = 1}^{M} {\overline{h}}_{UI , m} {ϕ}_{m} ( t ) + {n}_{IRS} ( t ) \qquad [ Equation 6 ]$$

In [Equation 6], x(t) denotes a signal received at the t-th time slot in the active element of the RIS, P_{UL} denotes uplink transmit power, M denotes the number of UEs, h̅_{UI,m} denotes a matrix with a size of L_{act}×1, which denotes the channel between the m-th UE and the active elements of the RIS, φₘ(t) denotes a pilot sequence transmitted by the m-th UE at the t-th time slot, and n_{RIS}(t) denotes noise received in the RIS at the t-th time slot. h̅_{UI,m} may be understood as a channel composed of elements corresponding to the indices of the active elements in h_{UI,m}.

By connecting the received signals during the time τ_{U}, a matrix as shown in [Equation 7] below may be determined.

$$\begin{matrix}X = [ x ( 1 ) , … , x ( {τ}_{U} ) ] \\ = \sqrt{{P}_{UL}} {H}_{UI , act} {Φ}^{T} + N\end{matrix} \qquad [ Equation 7 ]$$

In [Equation 7], X denotes the received signals during time τ_{U}, x(t) denotes the signal received at the t-th time slot in the active element of the RIS, P_{UL} denotes uplink transmit power, H_{UI,act} denotes the channel between the UEs and the active elements, Φ denotes a matrix containing all pilot sequences transmitted from the UEs, and N denotes noise received during time cu. H_{UI,act} is a matrix with a size of L_{act}×M, which is [h̅_{UI,1}, . . . , h̅_{UI,M}], Φ denotes a matrix with a size of τ_{U}×M, which is [φ₁, . . . , φ_{M}], and N is a matrix with a size of L_{act}×τ_{U}, which is [n_{RIS}(I), . . . , n_{RIS}(τ_{U})].

If τ_{U}=M is set as a minimum sequence length satisfying Φ^{T}Φ*=I_{M}, the estimated sub-channel between the UEs and the RIS may be determined as shown in [Equation 8] below.

$$\begin{matrix}{\tilde{H}}_{UI , act} = \frac{1}{\sqrt{{P}_{UL}}} X {Φ}^{*} \\ = {H}_{UI , act} + \frac{1}{\sqrt{{P}_{UL}}} N {Φ}^{*}\end{matrix} \qquad [ Equation 8 ]$$

In [Equation 8], \tilde{H}_{UI,act} denotes the estimation of the sub-channel between the UEs and the RIS, P_{UL} denotes uplink transmit power, X denotes received signals during time τ_{U}, Φ denotes a matrix containing all pilot sequences transmitted from the UEs, H_{UI,act} denotes the channel between the UEs and the active elements, and N denotes noise received during time τ_{U}.

The rank of the channel between the UEs and the RIS may be determined as follows.

If the channel between the UEs and the RIS is defined as H_{UI}=[h_{UI,1}, . . . , h_{UI,M}], and the covariance matrix between each UE and the RIS is defined as K=Aμ₁R, the entire channel between the UEs and the RIS may be expressed as in [Equation 9] below.

$${H}_{UI} = {K}^{\frac{1}{2}} Z \qquad [ Equation 9 ]$$

In [Equation 9], H_{UI} denotes a channel between the UEs and the RIS, K denotes a covariance matrix between each UE and the RIS, and Z denotes a probability distribution. Z is a matrix with a size of L×M, and each column is independent and has the same distribution of [symbol] (0,I_{L}).

Similarly, the entire sub-channel between the UEs and RIS may be expressed as [Equation 10] below.

$${H}_{UI , act} = {( {K}_{act} )}^{\frac{1}{2}} Z \qquad [ Equation 10 ]$$

In [Equation 10], H_{UI,act} denotes a channel between the UEs and the active elements of the RIS, K_{act} denotes a covariance matrix between each UE and the active elements of the RIS, and Z denotes a probability distribution.

$${( {K}_{a c t} )}^{\frac{1}{2}}$$

is composed of L_{act} rows of

$${K}^{\frac{1}{2}}$$

corresponding to the indices of the active elements. In order to analyze the rank of H_{UI,act}, first, the analysis of the rank of

$${( {K}_{act} )}^{\frac{1}{2}}$$

is necessary. An example of the CDF (cumulative distribution function) of the rank of

$${( {K}_{act} )}^{\frac{1}{2}}$$

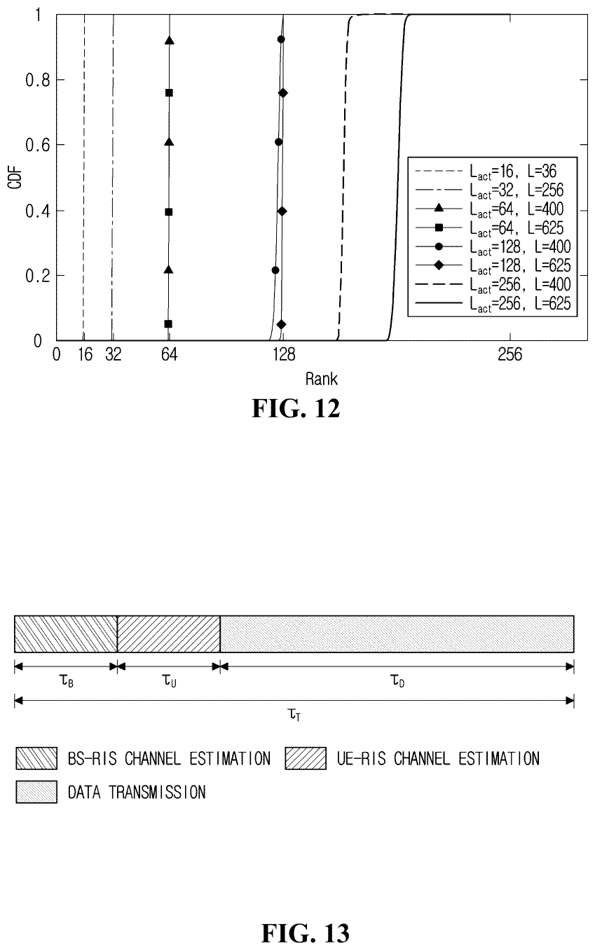

according to L_{act} and L, where Aμ₁=1, is as shown in FIG. 12. FIG. 12 shows a probability distribution of a rank according to the number of active elements in a RIS according to an embodiment of the present disclosure. In FIG. 12, the positions of the active elements were randomly generated 1,000 times for each graph. Referring to FIG. 12, if L_{act} is sufficiently smaller than L, it is confirmed that

$${( {K}_{act} )}^{\frac{1}{2}}$$

has a full rank with high probability. In general, it is desirable to set the number of active elements to be sufficiently smaller than the total number of RIS elements in order to reduce training overhead and power consumption. Therefore, it can be said that it is reasonable to assume that

$${( {K}_{act} )}^{\frac{1}{2}}$$

has a full rank.

If

$${( {K}_{act} )}^{\frac{1}{2}}$$

has a full rank, it may be confirmed that H_{UI,act} has a full rank. If an arbitrary unitary matrix U with a size of L×L satisfying UU^{H}=I_{L} is defined, H_{UI,act} may be expressed as in [Equation 11] below.

$$\begin{matrix}{H}_{UI , act} = {( {K}_{act} )}^{\frac{1}{2}} {UU}^{H} Z \\ = {( {K}_{act} )}^{\frac{1}{2}} U \tilde{Z}\end{matrix} \qquad [ Equation 11 ]$$

In [Equation 11], H_{UI,act} denotes a channel between the UEs and the active elements of the RIS, K_{act} denotes a covariance matrix between each UE and the active elements of the RIS, U denotes a unitary matrix, and Z denotes a probability distribution.

\tilde{Z} is U^{H}Z, which has the same distribution as Z. When

$${( {K}_{act} )}^{\frac{1}{2}}$$

has a full rank, U may be decomposed into U=[U₁ U₂], where each column of U₁, which is a matrix with a size of L×L_{act}, and U₂, which is a matrix with a size of L×(L−L_{act}), corresponds to the conjugate of the orthonormal basis of

$$R ( {( {( {K}_{act} )}^{\frac{1}{2}} )}^{T} ) and N ( {( {K}_{act} )}^{\frac{1}{2}} ) .$$

Here, R(·) and N(·) denote the column space and null space of the matrix. Considering this, [Equation 11] may be expressed as [Equation 12] below.

$$\begin{matrix}{( {K}_{act} )}^{\frac{1}{2}} U \tilde{Z} = {( {K}_{act} )}^{\frac{1}{2}} [ {U}_{1} {U}_{2} ] \tilde{Z} \\ = [ {( {K}_{act} )}^{\frac{1}{2}} {U}_{1} 0 ] \tilde{Z} \\ = {( {K}_{act} )}^{\frac{1}{2}} {U}_{1} \tilde{Z}\end{matrix} \qquad [ Equation 12 ]$$

In [Equation 12], K_{act} denotes a covariance matrix between each UE and active elements of the RIS, U denotes a unitary matrix, \tilde{Z} denotes a product of the Hermitian of the unitary matrix and a probability distribution, and U₁ and U₂ denote matrices that separate the unitary matrix from the column axis.

Each column of \hat{Z} is mutually independent, has the same [symbol] (0,I_{Lact})distribution, and the rank of \hat{Z} is min(L_{act},M) If the first column of U₁ is set to the Hermitian of the first row of

$${( {K}_{act} )}^{\frac{1}{2}} , {( {K}_{act} )}^{\frac{1}{2}} {U}_{1}$$

becomes a lower triangular matrix with a size of L×L. Since multiplying any matrix by a full-rank square matrix preserves the rank of the matrix, the rank of [Equation 12] is equal to min(L_{act},M), which means that H_{UI,act} is a full rank.

The channel between the UEs and the RIS may be estimated as follows. Roughly speaking, the RIS selects M rows with the largest correlation and normalizes the norm of the estimated rows. The operation of selecting M rows and the operation of normalization are described in detail as follows.

Through the aforementioned rank analysis, it may be assumed that H_{UI,act} is a full rank when the number of active elements is sufficiently small compared to the total number of elements. The present disclosure assumes that the number of active elements is greater than or equal to the total number of UEs. In this case, H_{UI,act} has a full column rank, and the rank of H_{UI,act} becomes M. As a result, since any M rows of H_{UI,act} become a row basis for the entire channel, other rows of H_{UI} may be expressed as a linear combination of the bases. If the set of indices of the active elements of the RIS is defined as [symbol] _{act}, L−L_{act} rows corresponding to indices not included in [symbol] _{act} are required to be estimated through the linear combination in order to estimate the entire channel. However, since the search range of linear combination coefficients for linear combination is very wide, it is not easy to find the exact linear combination coefficients of the row to be estimated.

Accordingly, the present disclosure focuses on the fact that the bases having high correlation can well express the rows to be estimated. Therefore, in the present disclosure, the bases having high correlation with the rows to be estimated when estimating the channel are selected, and the correlation coefficients are utilized as linear combination coefficients. Since all the columns of H_{UI} have the same spatial correlation matrix R, the element values of R denote the correlation between the rows of H_{UI}. Therefore, the element values of R may be used as correlation coefficients.

When estimating a channel, the proposed technique finds M rows with high correlation with the row to be estimated in \tilde{H}_{UI,act}. As a coefficient of linear combination, a weighted linear combination coefficient may be used to give a large weight to a row with more correlations, and an exponential weighted linear combination coefficient is considered among possible methods. In the present disclosure, the indices of the M rows in \tilde{H}_{UI,act} with the largest correlation with the [symbol] -th row of H_{UI} are expressed as [symbol] , . . . , [symbol] , and the indices of the corresponding rows in the H_{UI} are expressed as [symbol] , . . . , [symbol] . Accordingly, the exponential weighted linear combination coefficient may be expressed as in [Equation 13]

$${R}_{ℓ , {ψ}_{m}^{( ℓ )}} = \{ \begin{matrix}+ exp ( α \cdot \vert {[ R ]}_{ℓ , {ψ}_{m}^{( ℓ )}} \vert ) , {[ R ]}_{ℓ , {ψ}_{m}^{( ℓ )}} \geq 0 \\ - exp ( α \cdot \vert {[ R ]}_{ℓ , {ψ}_{m}^{( ℓ )}} \vert ) , {[ R ]}_{ℓ , {ψ}_{m}^{( ℓ )}} < 0\end{matrix} \qquad [ Equation 13 ]$$

In [Equation 13], [symbol] denotes an exponential weighted linear combination coefficient, [symbol] denotes a row index of a channel between the UEs and the RIS, [symbol] denotes an index of M selected rows, α denotes a weighting coefficient, and [symbol] denotes an element of the [symbol] -th row and the [symbol] -th column of the covariance matrix.

In this case, the weighting coefficient α may be optimized numerically. For all [symbol] [symbol] , the estimated value of the [symbol] -th row of H_{UI} with the weighted linear coefficient applied is as in [Equation 14] below.

$${\hat{H}}_{UI} ( ℓ , : ) = {\sum }_{m = 1}^{M} {\overline{R}}_{ℓ , {ψ}_{m}^{( ℓ )}} {\tilde{H}}_{UI , act} ( {π}_{m}^{( ℓ )} , : ) . \qquad [ Equation 14 ]$$

In [Equation 14], Ĥ_{UI}( [symbol] ,:) denotes the estimated value of the H_{UI} of the channel matrix between the UEs and the RIS, [symbol] denotes the exponential weighted linear combination coefficient, and \tilde{H}_{UI,act}( [symbol] ,:) denotes the [symbol] -th row among the rows selected based on the correlation in the sub-channel estimation.

There is a possibility that the norm of the [symbol] -th row of the estimated H_{UI} is significantly different from the norm of the row of the actual channel. Therefore, an operation to modify the norm is required. Based on the statistical distribution of the norm of the row, the norm may be normalized as follows.

The present disclosure defines a matrix

$$S = {\sum }_{m = 1}^{M} {h}_{UI , m} {h}_{UI , m}^{H} .$$

S follows a complex Wishart distribution, has M degrees of freedom and a covariance matrix K, and may be expressed as [symbol] _{L}(M,K). The diagonal elements of S correspond to the squares of the norms of the rows of H_{UI}, and the covariance between two diagonal elements of S is expressed as in [Equation 15] below.

$$cov \{ {‖ {H}_{UI} ( a , : ) ‖}^{2} , {‖ {H}_{UI} ( b , : ) ‖}^{2} \} = {M ( {[ K ]}_{a , b} )}^{2} , ∀ a , b = 1 , … , L \qquad [ Equation 15 ]$$

In [Equation 15], cov{ } denotes a covariance operator, H_{UI}(a,:) denotes the a-th row in the channel matrix between the UEs and the RIS, M denotes a degree of freedom, K denotes a covariance matrix, and [K]_{a,b} denotes the elements of the a-th row and the b-th column of the covariance matrix.

The correlation coefficient between the squares of the norms of two rows of H_{UI} is proportional to the correlation coefficient between two elements of the RIS corresponding to the same index. Since M rows with high correlation are used during linear combination, the sample average of the norms of the rows used for linear combination may be used as a normalization coefficient. The normalization coefficient of the estimated row is as in [Equation 16] below.

$${N}_{ℓ} = \frac{1}{M} {\sum }_{m = 1}^{M} ‖ {\tilde{H}}_{UI , act} ( {π}_{m}^{( ℓ )} , : ) ‖ \qquad [ Equation 16 ]$$

In [Equation 16], [symbol] denotes the normalization coefficient of the [symbol] -th estimated row, M denotes the number of rows used to estimate the [symbol] -th row, and \tilde{H}_{UI,act}( [symbol] ,:) denotes the th [symbol] -th row among the rows selected based on the correlation in the sub-channel estimation.

Finally, for all [symbol] ∉ [symbol] _{act}, the estimated value of the [symbol] -th row of the H_{UI} with the weighted linear coefficient and the normalization coefficient applied is as in [Equation 17] below.

$${\hat{H}}_{UI} ( ℓ , : ) = \frac{{\sum }_{m = 1}^{M} {\overline{R}}_{ℓ , {ψ}_{m}^{( ℓ )}} {\tilde{H}}_{UI , act} ( {π}_{m}^{( ℓ )} , : )}{‖ {\sum }_{m = 1}^{M} {\overline{R}}_{ℓ , {ψ}_{m}^{( ℓ )}} {\tilde{H}}_{UI , act} ( {π}_{m}^{( ℓ )} , : ) ‖} {N}_{ℓ} \qquad [ Equation 17 ]$$

In [Equation 17], Ĥ_{UI}( [symbol] ,:)denotes the estimated value of [symbol] -th row of the H_{UI} of the channel matrix between the UEs and the RIS, [symbol] denotes the exponential weighted linear combination coefficient, \tilde{H}_{UI,act}( [symbol] ,:) denotes the [symbol] -th row among the rows selected based on the correlation in the sub-channel estimation, and [symbol] denotes the normalization coefficient of the [symbol] -th estimated row.

FIG. 13 shows an example of channel estimation and communication timing according to an embodiment of the present disclosure. FIG. 13 illustrates a timing diagram showing channel estimation and data transmission. Referring to FIG. 13, I_{T} denotes a coherence time, and it is assumed that during a time interval TT, a channel between a UE and a RIS and a channel between a RIS and a BS do not change to the extent that it affects communication performance. According to a channel estimation technique according to various embodiments, the RIS estimates a channel between the UE and the RIS during a time interval τ_{U}, and a channel between the RIS and the BS during a time interval τ_{B}, respectively. For example, τ_{B} and τ_{U} may be set to N and M. Then, during a time interval τ_{D}=τ_{T}−(τ_{B}+τ_{U}), the base station may transmit data.

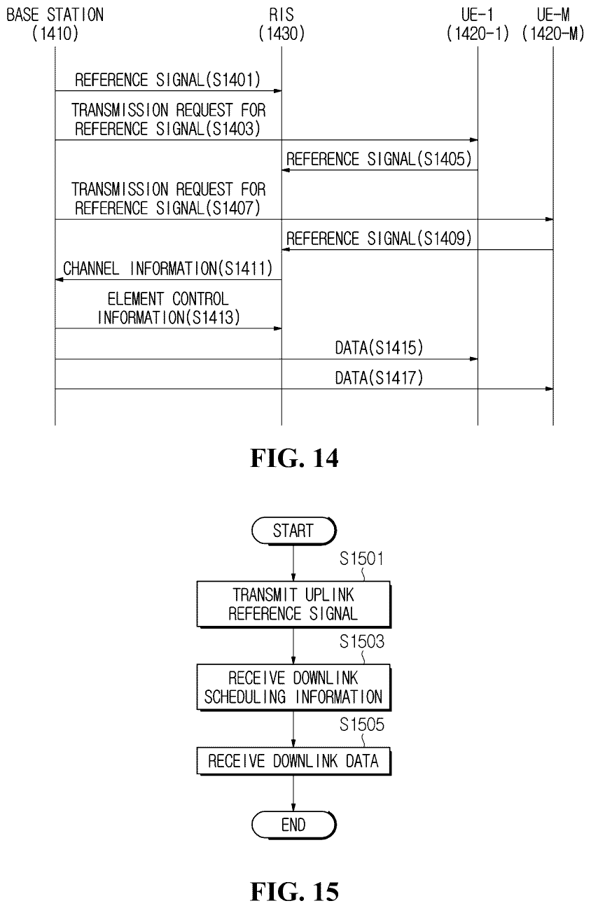

FIG. 14 shows an example of a downlink communication procedure according to an embodiment of the present disclosure. FIG. 14 illustrates signal exchange between a base station 1410, a plurality of UEs 1420-1 to 1420-M, and a RIS 1430.

Referring to FIG. 14, in step S1401, the base station 1410 transmits at least one reference signal to the RIS 1430. The base station 1410 may transmit at least one reference signal using multiple antennas. For example, the at least one reference signal may be based on a Zadoff-chu sequence.

In step S1403, the base station 1410 transmits a transmission request for the reference signal to the UE-1 1420-1. The transmission request for the reference signal may include configuration information for at least one reference signal. For example, the configuration information may indicate at least one of a sequence of at least one reference signal, a time-frequency resource allocated for at least one reference signal, power, and an antenna port. In step S1405, the UE-1 1420-1 transmits at least one reference signal. For example, the UE-1 1420-1 may transmit at least one reference signal according to the configuration information. At least one reference signal transmitted from the UE-1 1420-1 is received by the RIS 1430.

In step S1407, the base station 1410 transmits a transmission request for a reference signal to the UE-M 1420-M. The transmission request for the reference signal may include configuration information for at least one reference signal. For example, the configuration information may indicate at least one of a sequence of at least one reference signal, a time-frequency resource allocated for at least one reference signal, power, and an antenna port. In step S1409, the UE-M 1420-M transmits at least one reference signal. For example, the UE-M 1420-M may transmit at least one reference signal according to the configuration information. At least one reference signal transmitted from the UE-M 1420-M is received by the RIS 1430.

In step S1411, the RIS 1430 transmits channel information to the base station 1410. At this time, the RIS 1430 measures reference signals using active elements, estimates sub-channels based on the measurement results, and then estimates the entire channel from the sub-channels through linear combination. Here, the channel information may be transmitted through a backhaul link between the RIS 1430 and the base station 1410. For example, the channel information may be expressed in the form of a PMI (precoding matrix indicator).

In step S1413, the base station 1410 transmits control information for passive elements to the RIS 1430. The control information indicates a reflection coefficient (e.g., a phase coefficient) applied to each of the passive elements included in the RIS 1430 in order to maximize spectral efficiency. Specifically, the control information may include at least one of an adjustment value of a reflection coefficient, an index indicating a set of reflection coefficients, or values of reflection coefficients to be applied. For example, the control information may indicate reflection coefficients based on a codebook. Accordingly, the RIS 1430 may set the reflection coefficients of the passive elements to match the channel.

Although not illustrated in FIG. 14, an interface establishment procedure between the base station 1410 and the RIS 1430 has been performed in advance, and the base station 1410 and the RIS 1430 may transmit/receive the quantized reception values and the control information through the established interface. According to various embodiments, the interface between the base station 1410 and the RIS 1430 may be established on a direct path between the base station 1410 and the RIS 1430 or on a detour path via another entity.

In steps S1415 and S1417, the base station 1410 transmits downlink data to the plurality of UEs 1420-1 to 1420-M. That is, the base station 1410 may perform scheduling based on the channel information provided from the RIS 1430 and transmit downlink data to the plurality of UEs 1420-1 to 1420-M according to the scheduling result. At this time, the plurality of UEs 1420-1 to 1420-M may receive data signals using the same time-frequency resource.

In the embodiment described with reference to FIG. 14, the base station 1410 transmits at least one reference signal ahead of the plurality of UEs 1420-1 to 1420-M. However, according to another embodiment, the plurality of UEs 1420-1 to 1420-M may transmit the reference signals ahead of the base station 1410.

In the embodiment described with reference to FIG. 14, the plurality of UEs 1420-1 to 1420-M participate in the procedure. According to one embodiment, each of the plurality of UEs 1420-1 to 1420-M may logically use one transmit antenna. In another embodiment, at least portion of the plurality of UEs 1420-1 to 1420-M may utilize a plurality of logical transmit antennas. In this case, a UE utilizing the plurality of logical transmit antennas may perform operations corresponding to one logical transmit antenna on each transmit antenna. In other words, a UE utilizing the plurality of logical transmit antennas may be understood as a group of UEs utilizing one logical transmit antenna.

FIG. 15 shows an example of a procedure for receiving downlink data according to an embodiment of the present disclosure. FIG. 15 illustrates a method of operating a UE.

Referring to FIG. 15, in step S1501, the UE transmits at least one uplink reference signal. The at least one uplink reference signal may include a sounding reference signal (SRS) and may be transmitted through a resource allocated by a base station. That is, prior to transmitting the at least one reference signal, the UE may receive configuration information for the reference signal from the base station. The configuration information may include at least one of a time-frequency resource allocated for the at least one uplink reference signal, a sequence, a power or an antenna port.

In step S1503, the UE receives downlink scheduling information. That is, the UE receives information indicating resources allocated for downlink communication. In other words, the UE receives downlink control information (DCI) for downlink communication. The DCI indicates at least one of a modulation and coding scheme (MCS) or a time-frequency resource.

In step S1505, the UE receives downlink data. The UE may receive downlink data according to downlink scheduling information. Specifically, the UE may extract a signal mapped to an allocated resource from a downlink signal, and demodulate and decode the data.

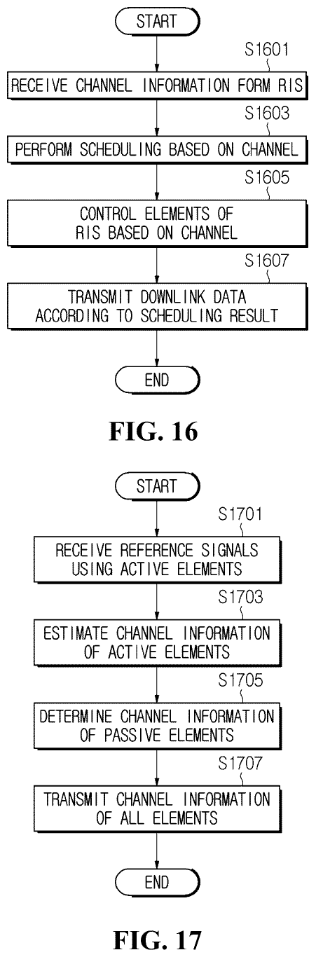

FIG. 16 shows an example of a procedure for transmitting downlink data according to an embodiment of the present disclosure. FIG. 16 illustrates a method of operating a base station.

Referring to FIG. 16, in step S1601, the base station receives channel information from a RIS. The channel information received from the RIS includes channel information between the base station and the RIS, and channel information between a UE and the RIS. The channel information includes information necessary for determining a channel matrix, and may include, for example, at least one PMI.

In step S1603, the base station performs scheduling based on the estimated channel. The base station may allocate resources to UEs based on the estimated channel, and determine at least one of reflection coefficients applied to precoders to be applied to signals to be transmitted to the UEs and elements of the RIS. The base station may perform scheduling by considering the channel, signal characteristics due to reflection of the RIS, combined gain of the reflected signal and the directly received signal, etc.

In step S1605, the base station controls the elements of the RIS based on the channel. Specifically, the base station determines reflection coefficients for each element of the RIS and transmits control information indicating the determined reflection coefficients to the RIS. At this time, the reflection coefficients are determined based on the channel between the base station and the RIS and the channel between the UE and the RIS. In step S1603, scheduling that does not utilize the RIS may be performed. In this case, the present step S1605 may be omitted.

In step S1607, the base station transmits downlink data according to the scheduling result. That is, the base station may control the reflection coefficients of the RIS, transmit downlink scheduling information to the UEs, and then transmit downlink data. If necessary, the base station may perform precoding on signals including downlink data. At this time, at least portion of the signals may be reflected by the RIS and transmitted to the UEs.

FIG. 17 shows an example of a procedure for estimating a channel according to an embodiment of the present disclosure. FIG. 17 illustrates a method of operating a RIS.

Referring to FIG. 17, in step S1701, the RIS receives reference signals using active elements. Here, the reference signals include at least one reference signal transmitted from a base station and reference signals transmitted from UEs. The RIS may measure the reference signals using the active elements and obtain measurement results. In other words, the RIS may obtain reception values for the reference signals using the active elements. According to various embodiments, the RIS may receive the reference signals using all or a portion of the active elements.

In step S1703, the RIS estimates channel information of the active elements. The RIS may estimate channel information of the active elements based on measurements for the reference signals. Since the active elements correspond to a portion of the elements included in the RIS, the RIS may obtain channel information of a portion of the elements. Since it is the channel information of a portion of all the elements, the obtained channel information may be referred to as sub-channel information, partial channel information, or other terms having equivalent technical meanings.

In step S1705, the RIS determines channel information of the passive elements. In other words, the RIS determines channel information of the remaining elements excluding the active elements. The RIS may determine the channel information of the passive elements based on the channel information of the active elements. According to one embodiment, the RIS may derive the channel information of the passive elements from the channel information of the active elements based on the correlation between the elements. Through this, the RIS may obtain channel information of all the elements.

In step S1707, the RIS transmits channel information of all the elements to the base station. Here, the channel information may include at least one of channel information between the base station and the RIS and channel information between the UEs and the RIS. That is, for scheduling of the base station, the RIS may provide the base station with at least one of channel information between the base station and the RIS and channel information between the UEs and the RIS. At this time, the channel information may be transmitted through a link (e.g., a wired backhaul link) different from at least one reference signal from the base station.

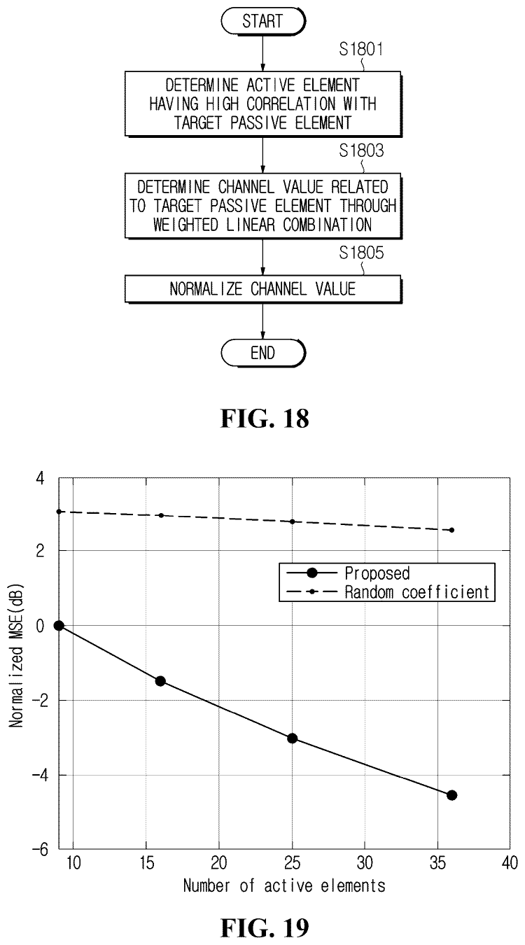

FIG. 18 shows an example of a procedure for determining and estimating a channel value related to a passive element according to an embodiment of the present disclosure. FIG. 18 illustrates a method of operating a RIS. FIG. 18 illustrates a procedure for determining a channel value for one passive element. Accordingly, when it is desired to obtain channel information of a plurality of passive elements, the procedure described below may be repeated or performed in parallel for each passive element.

Referring to FIG. 18, in step S1801, the RIS determines at least one active element having a high correlation with a target passive element. Here, high correlation means that it belongs to a predefined number of upper groups in the results of sorting numerical correlation values (e.g., absolute values of correlation coefficients) in descending order. That is, the RIS may check correlation values between the target passive element and active elements, and select a predefined number (e.g., M) of active element(s) in descending order of correlation values from the active element having the highest correlation value. To this end, the RIS may utilize a spatial correlation matrix between the transmitter of the reference signal and the RIS, which is determined based on the positions of the elements.

In step S1803, the RIS determines a channel value related to the target passive element through weighted linear combination. In other words, the RIS may determine a channel value related to the target passive element by weighted linear combination of the channel values for at least one determined active element. At this time, the weight applied to the channel value for at least one active element may be determined based on a correlation value with the target passive element.

In step S1805, the RIS normalizes the determined channel value. The channel value may be normalized by normalizing a norm of the value. According to one embodiment, the RIS may normalize the channel value based on a norm of a channel value associated with at least one active element used to determine the channel value of the target passive element. Through this, the determined channel value may be modified to be closer to an actual channel value.

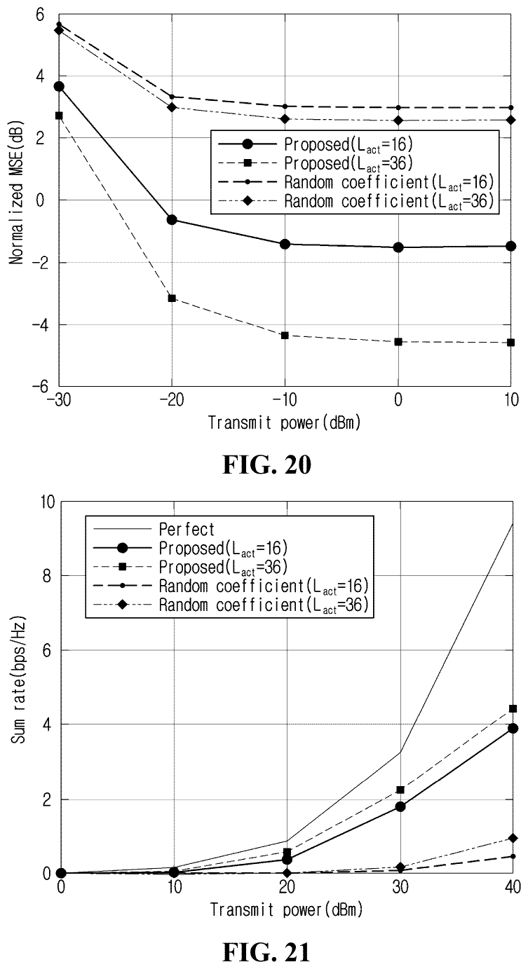

FIG. 19, FIG. 20 and FIG. 21 show the performance of a channel estimation technique according to an embodiment of the present disclosure. FIG. 19, FIG. 20 and FIG. 21 show the results of simulations performed in an environment set as follows. A base station includes N=8 antennas that are sufficiently spaced apart from each other, and M=8 UEs exist in the same cluster. The carrier frequency is 3.5 GHz. The elements of the RIS are arranged in a 16×16 UPA structure, and the horizontal length dₕ and the vertical length dᵥ of one element are λ/8. The positions of the active elements are set arbitrarily. The distance d_{BI} between the base station and the RIS, and the distance d_{UI} between the UEs and the RIS are 45 m and 18 m, respectively. The path loss exponents in large scale fading, i.e., the path loss exponent η_{BI} between the base station and RIS and the path loss exponent qui between the UEs and RIS, are 2.2 and 2.9, respectively, and the path loss η₀ at d₀=1 m is −20 dB. In order to obtain the covariance matrix between the RIS elements, μ₁=η₀(d_{UI}/d₀)^{η}^{_{UI}} and μ₁(d_{BI}/d₀)^{η}^{_{UI}} are set. The noise variances at the RIS and UE are σ²_{RIS}=σ²_{U}=−124 dBm. The lengths of the training sequences for estimating the sub-channels between the base station and RIS, and between the UE and RIS are set as τ_{B}=N and τ_{U}=M, respectively. The weighting coefficients α are set to 5.

The normalized MSE for the estimated channel between the UE and the RIS according to the number of active elements is shown in FIG. 19, and the expression of the normalized MSE is as in [Equation 18] below.

$$NMSE = \frac{1}{L} {\sum }_{ℓ = 1}^{L} \frac{{‖ {H}_{UI} ( ℓ , : ) - {\hat{H}}_{UI} ( ℓ , : ) ‖}^{2}}{{‖ {H}_{UI} ( ℓ , : ) ‖}^{2}} \qquad [ Equation 18 ]$$

In [Equation 18], H_{UI}( [symbol] ,:)denotes the value of the [symbol] -th row of the H_{UI} of the channel matrix between the UEs and the RIS, and Ĥ_{UI}( [symbol] ,:) denotes the estimated value of the [symbol] -th row of the H_{UI} of the channel matrix between the UEs and the RIS.

In FIG. 19, when estimating the channel, the uplink transmit power P_{UL} of the UE is set to 10 dBm. In order to compare the performance of the proposed technique, FIG. 19 shows the performance of a random coefficient that randomly selects M rows from \tilde{H}_{UI,act} and independently generates linear combination coefficients from [symbol] (0, 1). Referring to FIG. 19, it may be confirmed that the normalized MSE value of the proposed technique decreases as the number of active elements increases. This is because, as the number of active elements increases, there is a greater possibility that a basis with a high correlation may be used for more rows when estimating rows that do not correspond to the indices of the rows of the active elements, and thus the channel estimation is better. When examining the performance difference, it may be confirmed that the proposed technique shows a lower normalized MSE value than the random coefficient technique, and the difference in MSE values increases as the number of active elements increases. Therefore, it may be interpreted that using rows with high correlation for linear combination is significant in increasing the channel estimation performance.

FIG. 20 shows the normalized MSE for an estimated channel between UEs and a RIS according to the uplink transmit power of a UE. Referring to FIG. 20, it is confirmed that as the transmit power increases, pilot learning is performed better and thus the normalized MSE value of the proposed technique decreases. In the case of the proposed technique, it is confirmed that as the number of active elements increases, the normalized MSE value decreases significantly compared to the random coefficient technique, and the normalized MSE value is lower regardless of the transmit power.

FIG. 21 shows a sum rate according to the downlink transmit power of a base station. In FIG. 21, Perfect means the sum rate obtained for an actual channel, and the others mean the sum rates obtained for the estimated channels. The transmit power of the base station and the UE for the pilot was set to 10 dBm. Referring to FIG. 21, since the channel estimation is performed better when the number of active elements increases, a rate closer to Perfect is confirmed. In addition, the proposed technique shows a higher sum rate than the random coefficient technique. When the downlink transmit power is 30 dBm, it is confirmed that the proposed technique provides a sum rate of 70% compared to Perfect even if only 36 out of 256 elements of the RIS are used as active elements.

As the examples of the proposal method described above may also be included in one of the implementation methods of the present disclosure, it is an obvious fact that they may be considered as a type of proposal methods. In addition, the proposal methods described above may be implemented individually or in a combination (or merger) of some of them. A rule may be defined so that information on whether or not to apply the proposal methods (or information on the rules of the proposal methods) is notified from a base station to a terminal through a predefined signal (e.g., a physical layer signal or an upper layer signal).

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
transmitting configuration information related to at least one downlink reference signal;
transmitting the at least one downlink reference signal;
transmitting configuration information related to an uplink reference signal to at least one user equipment (UE);
receiving channel information from a reflecting intelligent surface (RIS);
transmitting control information indicating a scheduling result for transmitting downlink data to the at least one UE; and
transmitting the downlink data to the at least one UE according to the scheduling result,
wherein the channel information comprises channels values for a portion and a remainder of elements determined based on reception values of the uplink reference signal and the downlink reference signal measured using the portion of the elements included in the RIS.

2. The method of claim 1, wherein the channel information comprises channel information between the at least one UE and the RIS and channel information between a base station and the RIS.

3. The method of claim 1, further comprising transmitting, to the RIS, information related to reflection coefficients of the elements of the RIS.

4. The method of claim 1,
wherein the portion of the elements comprise at least one active element, and
wherein the remainer of the elements comprise passive elements.

5. A method comprising:
receiving reference signals from a base station and at least one user equipment (UE) using a portion of elements;
performing measurement on the reference signals;
estimating a first partial channel related to a portion of channels for elements included in a reflecting intelligent surface (RIS) based on a result of the measurement;
estimating a second partial channel related to a remainder of elements excluding the portion of elements based on the first partial channel; and
transmitting information related to a channel including the first partial channel and the second partial channel to the base station.

6. The method of claim 5,
wherein the portion of the elements comprise at least one active element, and
wherein the remainder of elements comprise passive elements.

7. The method of claim 6, wherein the estimating the second partial channel comprises:
determining the at least one active element based on a correlation between a target passive element and the at least one active elements; and
determining a channel value related to the target passive element by weighted linear combination of a channel value related to the determined at least one active element.

8. The method of claim 7, wherein the at least one active element is determined based on a spatial correlation matrix between the base station and the RIS or between the at least one UE and the RIS.

9. The method of claim 5, wherein at least one reference signal from the base station and information transmitted to the base station are transmitted through different links.

10. An apparatus comprising:
a transceiver; and
a processor connected to the transceiver,
wherein the processor is configured to:
transmit configuration information related to at least one downlink reference signal;
transmit the at least one downlink reference signal;
transmit configuration information related to an uplink reference signal to at least one user equipment (UE);
receive channel information from a reflecting intelligent surface (RIS);
transmit control information related to a scheduling result for transmitting downlink data to the at least one UE; and
transmit the downlink data to the at least one UE according to the scheduling result,
wherein the channel information comprises channels values channel values for a portion and a remainder of elements determined based on reception values of the uplink reference signal and the downlink reference signal measured using the portion of the elements included in the RIS.

11-12. (canceled)
